(19) United States
(12) Patent Application Publication
(10) Pub. No.: US 2014/0009019 A1
(43) Pub. Date: Jan. 9, 2014

(54) SPINDLE MOTOR

(71) Applicant: SAMSUNG ELECTRO-MECHANICS CO., LTD., Suwon (KR)

(72) Inventors: Jung Hwan SONG, Suwon (KR); Shin Young CHEONG, Suwon (KR); Heung Suk GO, Suwon (KR)

(73) Assignee: SAMSUNG ELECTRO-MECHANICS CO., LTD., Suwon (KR)

(21) Appl. No.: 13/652,678

(22) Filed: Oct. 16, 2012

(30) Foreign Application Priority Data
Jul. 4, 2012 (KR) 10-2012-0073054

(51) Int. Cl. H02K 7/08

(52) U.S. Cl. 310/90

(57) ABSTRACT

A spindle motor includes a base member formed of a magnetic material; a lower thrust member installed in the base member; a shaft fixedly installed on at least one of the lower thrust member and the base member; a sleeve rotatably supporting the shaft by fluid dynamic pressure and disposed above the lower thrust member to form a thrust dynamic pressure bearing together with the lower thrust member at the time of rotation thereof; a rotor hub coupled to the sleeve to rotate together therewith; and an upper thrust member fixedly installed on the shaft to be positioned above the sleeve and forming a thrust dynamic pressure bearing together with the sleeve at the time of rotation of the sleeve, wherein upward thrust dynamic pressure generated between the lower thrust member and the sleeve is greater than downward thrust dynamic pressure generated between the upper thrust member and the sleeve.

### CROSS-REFERENCE TO RELATED APPLICATIONS

This application claims the priority of Korean Patent Application No. 10-2012-0073054 filed on Jul. 4, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to a disk using a read/write head.

The hard disk drive requires a disk driving device capable of driving the disk. In the disk driving device, a small-sized spindle motor is used.

Such a small-sized spindle motor has used a hydrodynamic bearing assembly. In the small-sized spindle motor, lubricating fluid is interposed between a shaft corresponding to a rotational axis of the hydrodynamic bearing assembly and a sleeve rotatably supporting the shaft, such that a bearing is formed by fluid pressure generated in the lubricating fluid, thereby supporting a rotating member.

In addition, a rotating member, one of the shaft or the sleeve, may be mounted with a rotor hub having a recording disk mounted thereon, wherein the rotor hub is fixedly coupled to an upper portion of the rotating member and has a disk shape in which it is extended in a radial direction based on the rotational axis thereof.

According to the related art, in the manufacturing of a base member provided in the hard disk drive, a post-processing scheme of die-casting aluminum (Al) and then removing burrs, or the like, generated due to the die-casting process, has been used.

However, in the die-casting scheme according to the related art, since a process of injecting molten aluminum (Al) into a mold to make a form is performed, high levels of temperature and pressure are required, such that a large amount of energy is required in the process and time and costs incurred therein may be increased.

US Patent Publication Nos. 2010/0315742, 2011/0019303 and 2012/0033328 have disclosed a spindle motor using a die-casting base member.

### SUUMMARY OF THE INVENTION

An aspect of the present invention provides a base member capable of being simply and rapidly manufactured and a spindle motor using the same.

According to an aspect of the present invention, there is provided a spindle motor including: a base member formed of a magnetic material; a lower thrust member installed in the base member; a shaft fixedly installed on at least one of the lower thrust member and the base member; a sleeve rotatably supporting the shaft by fluid dynamic pressure and disposed above the lower thrust member to form a thrust dynamic pressure bearing together with the lower thrust member at the time of rotation thereof; a rotor hub coupled to the sleeve to rotate together therewith; and an upper thrust member fixedly installed on an upper end portion of the shaft so as to be positioned above the sleeve and forming a thrust dynamic pressure bearing together with the sleeve at the time of the rotation of the sleeve, wherein upward thrust dynamic pressure generated between the lower thrust member and the sleeve is greater than downward thrust dynamic pressure generated between the upper thrust member and the sleeve.

An upper surface of the lower thrust member or a lower surface of the sleeve may be provided with a plurality of lower thrust dynamic pressure grooves, and a lower surface of the upper thrust member or an upper surface of the sleeve may be provided with a plurality of upper thrust dynamic pressure grooves.

The lower thrust dynamic pressure grooves may have a wider area than the upper thrust dynamic pressure grooves.

The number of lower thrust dynamic pressure grooves may be larger than the number of upper thrust dynamic pressure grooves.

A difference between a width of the lower thrust dynamic pressure groove in a circumferential direction and a width of a land between adjacent lower thrust dynamic pressure grooves in the circumferential direction may be smaller than a difference between a width of the upper thrust dynamic pressure groove in the circumferential direction and a width of a land between adjacent upper thrust dynamic pressure grooves in the circumferential direction.

The lower thrust dynamic pressure grooves may be shallower than the upper thrust dynamic pressure grooves.

The upper and lower thrust dynamic pressure grooves may have a spiral shape, and an angle formed between an extension line of an inner edge of the lower thrust dynamic pressure groove and the center of rotation and a tangent line at the inner edge of the lower thrust dynamic pressure groove may be smaller than an angle formed between an extension line of an inner edge of the upper thrust dynamic pressure groove and the center of rotation and a tangent line at the inner edge of the upper thrust dynamic pressure groove.

The upper and lower thrust dynamic pressure grooves may have a herringbone shape, and an angle formed between an outer wing portion and an inner wing portion of the lower thrust dynamic pressure groove may be larger than an angle formed between an outer wing portion and an inner wing portion of the upper thrust dynamic pressure groove.

The base member may be formed by performing plastic working on a rolled steel sheet.

According to another aspect of the present invention, there is provided a spindle motor including: a hydrodynamic bearing assembly including a shaft, a sleeve rotatably supporting the shaft by fluid dynamic pressure, and upper and lower thrust members protruding from the shaft in an outer radial direction to form thrust dynamic pressure bearings between the upper and lower thrust members and members facing the upper and lower thrust members at the time of relative rotation of the shaft and the sleeve; a base member having the hydrodynamic bearing assembly mounted thereon and formed of a magnetic material; an electromagnet mounted on the base member; and a magnet mounted in a rotating member, one of the shaft and the sleeve, to interact with the electromagnet, wherein upward thrust dynamic pressure floating the rotating member upwardly in an axial direction among thrust dynamic pressures generated between the upper and lower thrust members and the members facing the upper and lower thrust members, is greater than downward thrust dynamic pressure pulling the rotating member downwardly in the axial direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a partially cut-away exploded perspective view showing a sleeve and upper and lower thrust members according to an embodiment of the present invention;

FIGS. 4 and 5 are plan views of an upper or lower surface of a sleeve for illustrating a structure of a thrust dynamic pressure groove according to an embodiment of the present invention; and

FIG. 6 is a schematic cross-sectional view of a disk driving device using a spindle motor according to an embodiment of the present invention.

### DETAILED DESCRIPTION OF THE EMBODIMENTS

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Further, detailed descriptions related to well-known functions or configurations will be ruled out in order not to unnecessarily obscure subject matters of the present invention.

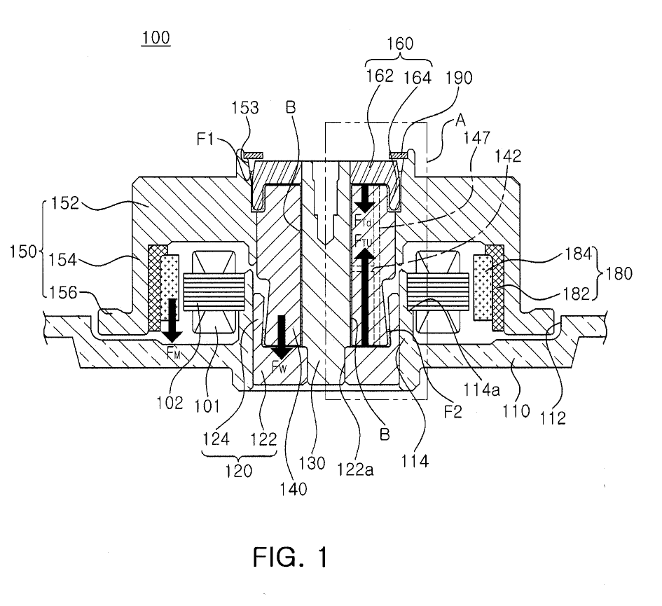

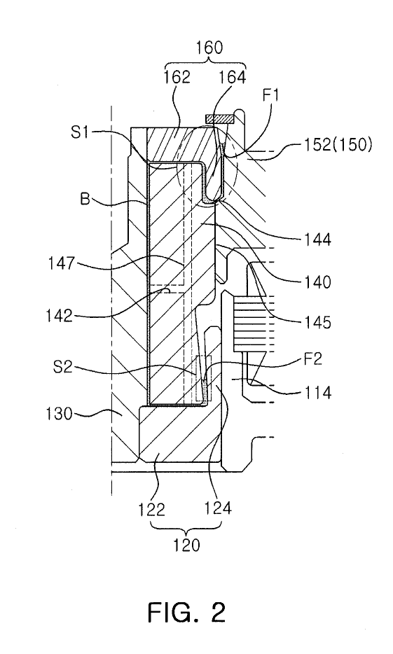

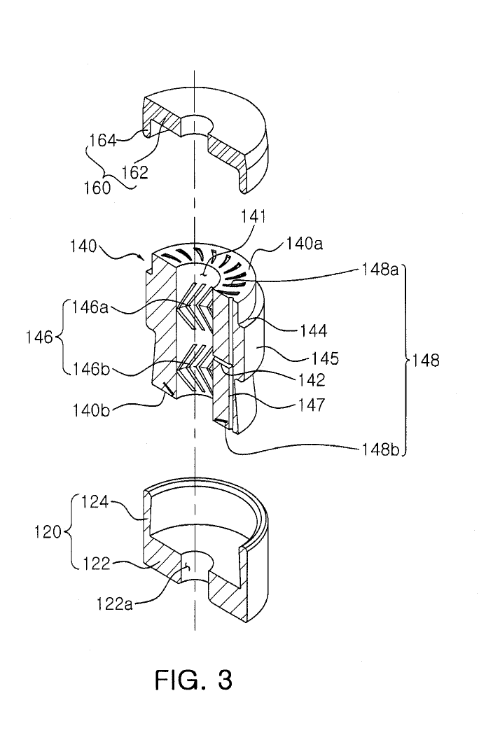

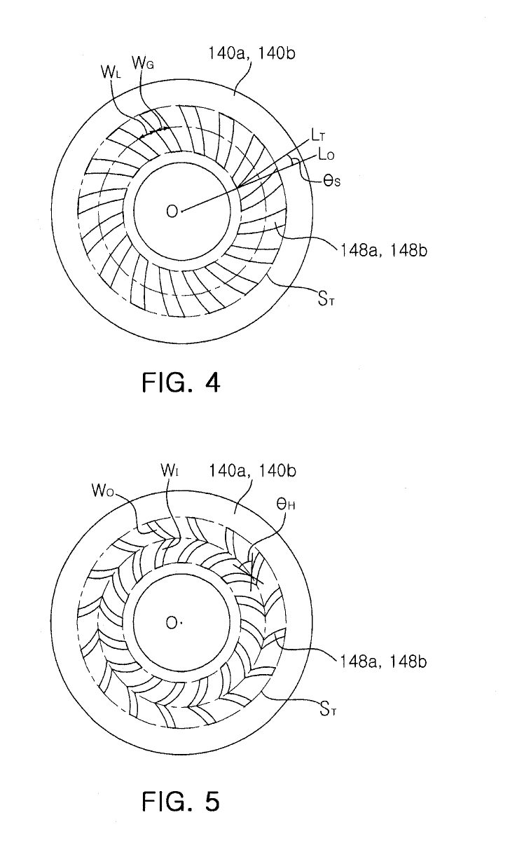

FIG. 1 is a schematic cross-sectional view showing a spindle motor according to an embodiment of the present invention; FIG. 2 is an enlarged view of part A of FIG. 1; FIG. 3 is a partially cut-away exploded perspective view showing a sleeve and upper and lower thrust members according to an embodiment of the present invention; and FIGS. 4 and 5 are plan views of an upper or lower surface of a sleeve for illustrating a structure of a thrust dynamic pressure groove according to an embodiment of the present invention.

Referring to FIGS. 1 through 3, a spindle motor 100 according to an embodiment of the present invention may include a base member 110, a lower thrust member 120, a shaft 130, a sleeve 140, a rotor hub 150, an upper thrust member 160, and a cap member 190.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the rotor hub 150 or from the outer peripheral surface of the rotor hub 150 toward the shaft 130, and a circumferential direction refers to a rotation direction along the outer peripheral surface of the rotor hub 150.

The spindle motor 100 according to the embodiment of the present invention use a hydrodynamic bearing assembly to allow a rotating member to rotate smoothly with respect to a fixed member.

Here, the hydrodynamic bearing assembly may be configured of members rotating by fluid pressure generated by a lubricating fluid. The hydrodynamic bearing assembly may include the sleeve 140, the shaft 130, the upper thrust member 160, and the rotor hub 150.

In addition, the rotating member, a member rotating with respect to the fixed member, may include the sleeve 140, the rotor hub 150, a magnet 184 provided in the rotor hub 150.

Further, the fixed member, a member fixed to the rotating member, may include the base member 110, the shaft 130, the lower thrust member 140, and the upper thrust member 160.

The base member 110 may include a mounting groove 112 so as to form a predetermined space with the rotor hub 150. In addition, the base member 110 may include a coupling part 114 extended upwardly in an axial direction and having a stator core 102 installed on an outer peripheral surface thereof.

In addition, the coupling part 114 may include a seat surface 114a provided on the outer peripheral surface thereof so that the stator core 102 may be seated and installed thereon. Further, the stator core 102 seated on the coupling part 114 may be disposed above the mounting groove 112 of the base member 110.

Meanwhile, the base member 110 according to the embodiment of the present invention may be manufactured by performing plastic working on a rolled steel sheet. More specifically, the base member 110 may be manufactured by a press method, a stamping method, a deep drawing method, or the like. However, the base member 110 is not limited to being manufactured by the above-mentioned method, but may be manufactured by various methods.

That is, since the base member 110 according to the embodiment of the present invention is manufactured by performing the plastic working on the rolled steel sheet, it may be basically formed of a magnetic material. Therefore, the magnet 184 mounted in the rotor hub 150 and the base member 110 may magnetically interact with each other to generate attractive force therebetween. Therefore, force between the magnet 184 and the base member 110, force acting in the axial direction, needs to be considered. A detailed description thereof will be provided below.

Meanwhile, since the base member 110 is manufactured by performing the plastic working on the rolled steel sheet, the base member 110 may be thin and have a uniform thickness. Therefore, it is not easy to integrally form the coupling part 114 with the base member 110. Accordingly, in the case of the base member 110 according to the embodiment of the present invention, the coupling part 114 may be manufactured as a separate member and then coupled to the base member 110 at the time of assembling of the spindle motor.

The lower thrust member 120 may be fixedly mounted in the base member 110. That is, the lower thrust member 120 may be insertedly installed in the coupling part 114. More specifically, an outer peripheral surface of the lower thrust member 120 may be bonded to an inner peripheral surface of the coupling part 114.

Meanwhile, the lower thrust member 120 may include a disk part 122 having an inner surface fixedly installed on the shaft 130 and an outer surface fixedly installed on the base member 110 and an extension part 124 extended from the disk part 122 upwardly in the axial direction.

That is, the lower thrust member 120 may have a cup shape with a hollow part. That is, the lower thrust member 120 may have a ‘└’ shaped cross section.

In addition, the disk part 122 may be provided with an installation hole 122a in which the shaft 130 is installed, and the shaft 130 may be insertedly mounted in the installation hole 122a.

In addition, the lower thrust member 120 may be included, together with the base member 110, in a fixed member, that is, a stator.

Meanwhile, the outer surface of the lower thrust member 120 may be bonded to an inner surface of the base member 110 by an adhesive and/or welding. In other words, the outer surface of the lower thrust member 120 may be fixedly bonded to an inner surface of the coupling part 114 of the base member 110.

In addition, a thrust dynamic pressure groove 148 for generating thrust fluid dynamic pressure may be formed in at least one of an upper surface of the lower thrust member 120 and a lower surface 140b of the sleeve 140. A detailed description thereof will be provided below with reference to FIGS. 3 through 5.

Further, the lower thrust member 120 may also serve as a sealing member for preventing the lubricating fluid from being leaked. A detailed description thereof will also be provided below with reference to FIGS. 2 and 3.

The shaft 130 may be fixedly installed on at least one of the lower thrust member 120 and the base member 110. That is, a lower end portion of the shaft 130 may be inserted into the installation hole 122a formed in the disk part 122 of the lower thrust member 120.

In addition, the lower end portion of the shaft 130 may be bonded to an inner surface of the disk part 122 by an adhesive and/or welding. Therefore, the shaft 130 may be fixed.

However, although the case in which the shaft 130 is fixedly installed on the lower thrust member 120 has been described by way of example in the present embodiment, the present invention is not limited thereto. That is, the shaft 130 may also be fixedly installed on the base member 110.

Meanwhile, the shaft 130 may be also included, together with the lower thrust member 120 and the base member 110, in the fixed member, that is, the stator.

Meanwhile, an upper surface of the shaft 130 may be provided with a coupling unit, for example, a screw portion having a screw coupled thereto so that a cover member (not shown) may be fixedly installed thereon.

The sleeve 140 may be rotatably installed on the shaft 130. To this end, the sleeve 140 may include a through-hole 141 into which the shaft 130 is inserted. Meanwhile, in the case in which the sleeve 140 is installed on the shaft 130, an inner peripheral surface of the sleeve 140 and an outer peripheral surface of the shaft 130 may be disposed to be spaced apart from each other by a predetermined interval to form a bearing clearance B therebetween. In addition, the bearing, clearance B may be filled with the lubricating fluid.

Meanwhile, the sleeve 140 may include a step surface 144 formed on the upper end portion thereof, wherein the step surface 144 is stepped with respect to an upper surface of the sleeve 140 to form a labyrinth shaped sealing part between the step surface 144 and the upper thrust member 160. The lubricating fluid may be firmly sealed by the labyrinth shaped sealing part formed by the step surface 144 and the upper thrust member 160.

Meanwhile, the upper thrust member 160 may have an inclined part 163 formed on an outer surface of an upper end portion thereof so as to form a first liquid-vapor interface F1 between the upper thrust member 160 and the rotor hub 160, wherein an upper portion of the inclined part 163 has a larger outer diameter than a lower portion thereof.

In other words, in order to form the first liquid-vapor interface F1 in a space between an outer peripheral surface of the upper thrust member 160 and an inner peripheral surface of the rotor hub 150, the inclined part 163 may be formed on the upper end portion of the upper thrust member 160 in a manner such that the upper portion of the inclined part 163 has a larger outer diameter than the lower portion thereof.

In addition, the outer peripheral surface of the sleeve 140 may be bonded to the rotor hub 150. That is, a lower portion of the step surface 144 may have a shape corresponding to that of an inner surface of the rotor hub 150, such that the rotor hub 150 may be fixedly installed thereon. That is, the sleeve 140 may include a bonding surface 145 formed on the outer peripheral surface thereof.

Here, the sleeve 140 and the rotor hub 150 may be formed integrally with each other. In the case in which the sleeve 140 and the rotor hub 150 are formed integrally with each other, since both of the sleeve 140 and the rotor hub 150 are provided as a single member, the number of components is reduced, whereby a product may be easily assembled and a tolerance of the assembly process may be significantly reduced.

Meanwhile, a lower end portion of the outer peripheral surface of the sleeve 140 may be inclined upwardly in an inner radial direction so as to form a liquid-vapor interface together with the extension part 124 of the lower thrust member 120.

That is, the lower end portion of the sleeve 140 may be inclined upwardly in the inner radial direction so that a second liquid-vapor interface F2 may be formed in a space between the outer peripheral surface of the sleeve 140 and the extension part 124 of the lower thrust member 120. That is, a sealing part S2 of the lubricating fluid may be formed in the space between the outer peripheral surface of the sleeve 140 and the extension part 124 of the lower thrust member 120.

As described above, since the second liquid-vapor interface F2 is formed in the space between the lower end portion of the sleeve 140 and the extension part 124, the lubricating fluid filling the bearing clearance B forms the first and second liquid-vapor interfaces F1 and F2.

In addition, the sleeve 140 may include a radial dynamic pressure groove 146 formed in an inner surface thereof in order to generate fluid dynamic pressure through the lubricating fluid provided in the bearing clearance B at the time of rotation thereof. That is, the radial dynamic pressure groove 146 may include upper and lower dynamic pressure grooves 146a and 146b, as shown in FIG. 3.

However, the radial dynamic pressure groove 146 is not limited to being formed in the inner surface of the sleeve 140, but may also be formed in the outer peripheral surface of the shaft 130. In addition, the radial dynamic pressure groove 146 may have various shapes such as a herringbone shape, a spiral shape, a helical shape, and the like.

In addition, the sleeve 140 may further include a circulation hole 147 allowing upper and lower surfaces thereof to be in communication with each other. The circulation hole 147 may discharge air bubbles contained in the lubricating fluid of the bearing clearance B to the outside and facilitate circulation of the lubricating fluid.

Further, the sleeve 140 may further include a communication hole 142 formed therein in the radial direction so as to allow the bearing clearance B formed by the sleeve 140 and the shaft 130 to be in communication with the circulation hole 147. The circulation hole 142 may increase a bearing span length, an interval between the upper and lower radial dynamic pressure grooves. That is, the communication hole 142 may allow a pumping direction of the upper and the lower radial dynamic pressure grooves 146a and 146b to be flexibly utilized, thereby diversifying a design of the motor.

The rotor hub 150 may be coupled to the sleeve 140 to rotate together therewith.

The rotor hub 150 may include a rotor hub body 152 provided with an insertion part in which the upper thrust member 160 is insertedly disposed, a mounting part 154 extended from an edge of the rotor hub body 152 and including a magnet assembly 180 mounted on an inner surface thereof, and an extension part 156 extended from an edge of the mounting part 154 in the outer radial direction.

Meanwhile, a lower end portion of an inner surface of the rotor hub body 152 may be bonded to the outer surface of the sleeve 140. That is, the lower end portion of the inner surface of the rotor hub body 152 may be bonded to the bonding surface 145 of the sleeve 140 by an adhesive and/or welding.

Therefore, at the time of rotation of the rotor hub 150, the sleeve 140 may rotate together with the rotor hub 150.

In addition, the mounting part 154 may be extended from the rotor hub body 152 downwardly in the axial direction. Further, the mounting part 154 may include the magnet assembly 180 fixedly installed on the inner surface thereof.

Meanwhile, the magnet assembly 180 may include a yoke 182 fixedly installed on the inner surface of the mounting part 154 and a magnet 184 installed on an inner peripheral surface of the yoke 182.

The yoke 182 may serve to direct a magnetic field from the magnet 184 toward the stator core 102 to increase magnetic flux density. Meanwhile, the yoke 182 may have a circular ring shape and one end portion thereof is bent so as to increase the magnetic flux density by the magnetic field generated from the magnet 184.

The magnet 184 may have an annular ring shape and be a permanent magnet generating a magnetic field having a predetermined strength by alternately magnetizing an N pole and an S pole in the circumferential direction.

Meanwhile, the magnet 184 may be disposed to face a front end of the stator core 102 having a coil 101 wound therearound and electromagnetically interact with the stator core 102 having the coil 101 wound therearound to generate driving force for rotating the rotor hub 150.

That is, when power is supplied to the coil 101, the driving force rotating the rotor hub 150 is generated by the electromagnetic interaction between the stator core 102 having the coil 101 wound therearound and the magnet 184 disposed to face the stator core 102, such that the rotor hub 150 may rotate together with the sleeve 140.

The upper thrust member 160 may be fixedly installed on the upper end portion of the shaft 130 and form the liquid-vapor interface together with the sleeve 140 or the rotor hub 150.

Meanwhile, the upper thrust member 160 may include a body 162 having an inner surface bonded to the shaft 130 and a protrusion part 164 extended from the body 162 and forming the liquid-vapor interface together with the inclined part 163.

The protrusion part 164 may be extended from the body 162 downwardly in the axial direction and have an inner surface facing the outer surface of the sleeve 140 and an outer surface facing the inner surface of the rotor hub 150.

In addition, the protrusion part 164 may be extended from the body 162 so as to be in parallel with the shaft 130.

Further, the upper thrust member 160 may be insertedly disposed in a space formed by the upper end portion of the outer peripheral surface of the shaft 130, the outer surface of the sleeve 140, and the inner surface of the rotor hub 150.

In addition, the upper thrust member 160, a fixed member fixedly installed together with the base member 110, the lower thrust member 120, and the shaft 130, may configure the stator.

Meanwhile, since the upper thrust member 160 is fixedly installed on the shaft 130 and the sleeve 140 rotates together with the rotor hub 150, the first liquid-vapor interface F1 may be formed in a space between the rotor hub 150 and the protrusion part 164. Therefore, the inner surface of the rotor hub 150 may be provided with the inclined part 163.

The protrusion part 164 of the upper thrust member 160 may be disposed in a space formed by the sleeve 140 and the rotor hub 150. In addition, the lubricating fluid may be provided in a labyrinth form in the spaces each formed by the sleeve 140 and a lower surface of the body 162 of the upper thrust member 160, the outer surface of the sleeve 140 and the inner surface of the protrusion part 164, and the outer surface of the protrusion part 164 and the inner surface of the rotor hub 150, thereby forming a sealing part S1.

Therefore, as shown in FIGS. 1 and 2, the first liquid-vapor interface F1 may be formed in the space formed by the outer surface of the sleeve 140 and the inner surface of the protrusion part 164 as well as the space formed by the outer surface of the upper thrust member 160 and the inner surface of the rotor hub 150. In the case in which the first liquid-vapor interface F1 is formed in the space formed by the outer surface of the sleeve 140 and the inner surface of the protrusion part 164, the outer surface of the sleeve 140 or the inner surface of the protrusion part 164 may be inclined to facilitate the sealing of the lubricating fluid.

Meanwhile, a thrust dynamic pressure groove 148a for generating thrust dynamic pressure may be formed in at least one of a lower surface of the upper thrust member 160 and the upper surface 140a of the sleeve 140 disposed to face the lower surface of the upper thrust member 160.

In addition, the upper thrust member 160 may also serve as a sealing member preventing the lubricating fluid filling the bearing clearance B from being leaked upwardly.

Meanwhile, in the case in which a rotating member (namely, the sleeve) and a fixed member (namely, the upper and lower thrust members) form liquid-vapor interfaces (the first and second liquid-vapor interfaces F1 and F2), the rotating member, the sleeve 140 is disposed inwardly of the fixed member in the radial direction, whereby the scattering of the lubricating fluid may be reduced by centrifugal force. However, this may be realized only when both of the first and second liquid-vapor interfaces F1 and F2 are formed between the sleeve and the upper and lower thrust members.

That is, in the case of the embodiment of the present invention shown in FIGS. 1 and 2, the first liquid-vapor interface F1 may be formed between the upper thrust member 160 and the rotor hub 150. Therefore, in this case, at the time of rotation of the rotor hub 150, the lubricating fluid is moved in the outer radial direction by centrifugal force, such that the lubricating fluid may be scattered.

Accordingly, the spindle motor 100 according to the embodiment of the present invention may include the cap member 190 covering a space formed by the upper thrust member 150 and the rotor hub 150.

The cap member 190 may have a ring shape and have an outer edge fixed to an inner portion of the rotor hub 150.

Meanwhile, in the spindle motor 100 according to the embodiment of the present invention, the base member 110 may be manufactured by performing the plastic working (a pressing process, or the like) on the rolled steel sheet. In this case, magnetic force acts between the magnet 184 provided in the rotor hub 150 and the base member 110, such that force pulling the rotor hub 150 downwardly may be generated.

Therefore, in order for the spindle motor 100 to smoothly rotate and operate, magnetic force acting between the magnet 184 and the base member 110, force acting in the axial direction at the time of driving the spindle motor 100, needs to be considered.

That is, force acting on the rotating member including the rotor hub 150 and the sleeve 140 downwardly in the axial direction and force acting on the rotating member upwardly in the axial direction need to be balanced with each other in order to allow the spindle motor 100 to smoothly rotate.

An example of the force acting on the rotating member downwardly in the axial direction may include dynamic pressure F_{Td} generated downwardly in the axial direction by the upper thrust dynamic pressure groove 148a, the magnetic force F_{M} acting between the magnet 184 and the base member 110, and self-weight F_{W} of the rotating member. In addition, an example of the force acting on the rotating member upwardly in the axial direction may include dynamic pressure F_{Tu} generated upwardly in the axial direction by the lower thrust dynamic pressure groove 148b.

Since it is required in the spindle motor 100 that the forces acting on the rotating member in the axial direction are balanced with each other, the following Equation 1 may be satisfied.

F_{Td}+F_{M}+F_{W}=F_{Tu} Equation 1

It may be concluded based on Equation 1 that the dynamic pressure F_{Tu} generated upwardly in the axial direction by the lower thrust dynamic pressure groove 148b should always be greater than the dynamic pressure F_{Td} generated downwardly in the axial direction by the upper thrust dynamic pressure groove 148a.

Therefore, in the spindle motor 100 according to the embodiment of the present invention, the upward thrust dynamic pressure generated between the lower thrust member 120 and the sleeve 140 may be greater than the downward thrust dynamic pressure generated between the upper thrust member 160 and the sleeve 140.

In order to increase thrust dynamic pressure, the upper and lower thrust dynamic pressure grooves may have different shapes.

Referring to FIGS. 4 and 5, in order to increase thrust dynamic pressure, 1) an area S_{T} of a thrust dynamic pressure groove region needs to be increased (the area S_{T} of the thrust dynamic pressure groove region indicates a width of a surface between a circumference forming an outer edge of the groove and a circumference forming an inner edge of the groove), 2) the number N_{T} of thrust dynamic pressure grooves needs to be increased, 3) a difference between a width W_{G} of the thrust dynamic pressure groove and a width W_{L} of a land formed between the thrust dynamic pressure grooves needs to be decreased (it is preferable that the width W_{G} of the thrust dynamic pressure groove and the width W_{L} of the land formed between the thrust dynamic pressure grooves are measured in the same circumferential direction having a predetermined radius), 4) a depth W_{D} of the thrust dynamic pressure groove needs to be decreased, 5) an angle θₛ formed between an extension line L₀ of the inner edge of the thrust dynamic pressure groove and the center O of rotation and a tangent line L_{T} at the inner edge of the thrust dynamic pressure groove needs to be decreased in the case in which the thrust dynamic pressure groove has a spiral shape, or 6) an angle θ_{H} formed by an outer wing portion W_{O} and an inner wing portion W_{I} of the thrust dynamic pressure groove needs to be increased in the case in which the thrust dynamic pressure groove has a herringbone shape.

The spindle motor 100 according to the embodiment of the present invention will be described in more detail with reference to FIGS. 4 and 5.

First, the area S_{T} of the thrust dynamic pressure groove region may be increased to increase thrust dynamic pressure. That is, the area of the lower thrust dynamic pressure groove 148b may be wider than that of the upper thrust dynamic pressure groove 148a.

Next, the number N_{T} of thrust dynamic pressure grooves may be increased to increase thrust dynamic pressure. That is, the number of lower thrust dynamic pressure grooves 148b may be lager than that of upper thrust dynamic pressure grooves 148a. However, in this case, the upper and lower thrust dynamic pressure grooves need to have an approximately similar size and be formed in approximately similar positions in the radial direction based on the center of rotation.

In addition, the difference between the width W_{G} of the thrust dynamic pressure groove and the width W_{L} of the land formed between the thrust dynamic pressure grooves may be decreased to increase thrust dynamic pressure. That is, the difference between the width of the lower thrust dynamic pressure groove 148b and an interval between adjacent lower thrust dynamic pressure grooves 148b may be smaller than the difference between the width of the upper thrust dynamic pressure groove 148a and an interval between adjacent upper thrust dynamic pressure grooves 148a. However, in this case, the upper and lower thrust dynamic pressure grooves need to have an approximately similar size and be formed in approximately similar positions in the radial direction based on the center of rotation.

Further, the depth N_{D} of thrust dynamic pressure grooves may be decreased to increase thrust dynamic pressure. That is, the lower thrust dynamic pressure grooves 148b may be shallower than the upper thrust dynamic pressure grooves 148a. However, in this case, the upper and lower thrust dynamic pressure grooves need to have an approximately similar size and be formed in approximately similar positions in the radial direction based on the center of rotation.

Further, in the case in which the thrust dynamic pressure groove has a spiral shape, the angle θₛ formed between the extension line L₀ of the inner edge of the thrust dynamic pressure groove and the center of rotation and the tangent line L_{T} at the inner edge of the thrust dynamic pressure groove may be decreased to increase thrust dynamic pressure. That is, the angle formed between the extension line of the inner edge of the lower thrust dynamic pressure groove 148b and the center of rotation and the tangent line at the inner edge of the lower thrust dynamic pressure groove 148b may be smaller than the angle formed between the extension line of the inner edge of the upper thrust dynamic pressure groove 148a and the center of rotation and the tangent line at the inner edge of the upper thrust dynamic pressure groove 148a. However, in this case, the upper and lower thrust dynamic pressure grooves need to have an approximately similar size and be formed in approximately similar positions in the radial direction based on the center of rotation.

Further, in the case in which the thrust dynamic pressure groove has a herringbone shape, the angle formed between the outer wing portion W_{O} and the inner wing portion W_{I} of the thrust dynamic pressure groove may be increased. That is, the angle formed between the outer wing portion and the inner wing portion of the lower thrust dynamic pressure groove 148b may be larger than the angle formed between the outer wing portion and the inner wing portion of the upper thrust dynamic pressure groove 148a. However, in this case, the upper and lower thrust dynamic pressure grooves need to have an approximately similar size and be formed in approximately similar positions in the radial direction based on the center of rotation.

Although a shaft fixed type structure in which the rotor hub is coupled to the sleeve to rotate has been described in the embodiments of FIGS. 1 through 5, the present invention may also applied to a shaft rotating type structure in which the rotor hub is coupled to the shaft to rotate.

That is, the present invention may be applied to any structure of a spindle motor as long as the spindle motor uses a hydrodynamic bearing assembly.

More specifically, the present invention may be applied to any structure of a spindle motor as long as the spindle motor includes a hydrodynamic bearing assembly including a shaft, a sleeve rotatably supporting the shaft by fluid dynamic pressure, and upper and lower thrust members protruding from the shaft in an outer radial direction to form thrust dynamic pressure bearings between the upper and lower thrust members and members facing the upper and lower thrust members, respectively, at the time of relative rotation of the shaft and the sleeve.

Here, the upper and lower thrust members protruding from the shaft in the outer radial direction may include various components such as a separate thrust member, a rotor hub, a stopper, and the like.

Further, the hydrodynamic bearing assembly needs to be mounted on a base member formed of a magnetic material to generate magnetic force between the base member and a magnet mounted in a rotating member.

The magnet mounted in the rotating member may interact with an electromagnet mounted on the base member to provide rotational driving force.

According to the embodiment of the present invention, the upward thrust dynamic pressure floating the rotating member upwardly in the axial direction among thrust dynamic pressures generated between the upper and lower thrust members provided at the shaft and the members facing the upper and lower thrust members, respectively, may be greater than the downward thrust dynamic pressure pulling the rotating member downwardly in the axial direction. The reason is that only in this case, the force pulling the rotating member downwardly in the axial direction by the magnetic force between the base member and the magnet may be supplemented by the upward thrust dynamic pressure.

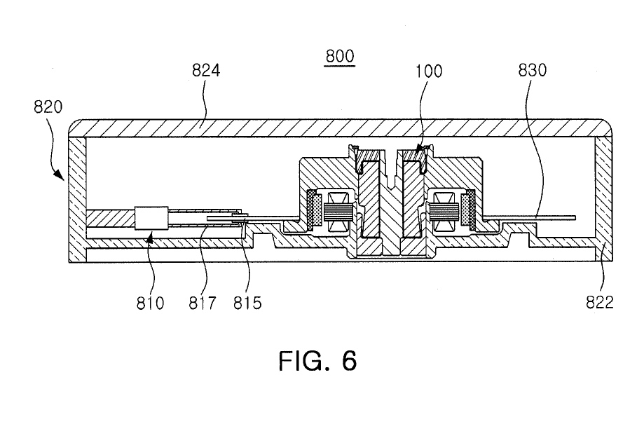

FIG. 6 is a schematic cross-sectional view of a disk driving device using the spindle motor according to the embodiment of the present invention.

Referring to FIG. 6, a recording disk driving device 800 having the spindle motor 100 according to the embodiment of the present invention mounted therein may be a hard disk driving device and include the spindle motor 100, a head transfer part 810, and a housing 820.

The spindle motor 100 may have all the characteristics of the spindle motor according to the above-described embodiments of the present invention and have a recording disk 830 mounted thereon.

The head transfer part 810 may transfer a magnetic head 815 detecting information of the recording disk 830 mounted on the spindle motor 100 to a surface of the recording disk of which the information is to be detected.

Here, the magnetic head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100 and the head transfer part 810 therein.

As set forth above, in the spindle motor according to the embodiments of the present invention, the base member is simply and rapidly manufactured in a press scheme, or the like, whereby productivity may be improved. In addition, a thickness of the base member is reduced, whereby thinness and lightness of the spindle motor may be implemented. Further, forces acting in the axial direction are balanced with each other, whereby the spindle motor may be stably operated.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member formed of a magnetic material;
a lower thrust member installed in the base member;
a shaft fixedly installed on at least one of the lower thrust member and the base member;
a sleeve rotatably supporting the shaft by fluid dynamic pressure and disposed above the lower thrust member to form a thrust dynamic pressure bearing together with the lower thrust member at the time of rotation thereof;
a rotor hub coupled to the sleeve to rotate together therewith; and
an upper thrust member fixedly installed on an upper end portion of the shaft so as to be positioned above the sleeve and forming a thrust dynamic pressure bearing together with the sleeve at the time of the rotation of the sleeve,
wherein upward thrust dynamic pressure generated between the lower thrust member and the sleeve is greater than downward thrust dynamic pressure generated between the upper thrust member and the sleeve.

2. The spindle motor of claim 1, wherein an upper surface of the lower thrust member or a lower surface of the sleeve is provided with a plurality of lower thrust dynamic pressure grooves, and
a lower surface of the upper thrust member or an upper surface of the sleeve is provided with a plurality of upper thrust dynamic pressure grooves.

3. The spindle motor of claim 2, wherein the lower thrust dynamic pressure grooves have a wider area than the upper thrust dynamic pressure grooves.

4. The spindle motor of claim 2, wherein the number of lower thrust dynamic pressure grooves is larger than the number of upper thrust dynamic pressure grooves.

5. The spindle motor of claim 2, wherein a difference between a width of the lower thrust dynamic pressure groove in a circumferential direction and a width of a land between adjacent lower thrust dynamic pressure grooves in the circumferential direction is smaller than a difference between a width of the upper thrust dynamic pressure groove in the circumferential direction and a width of a land between adjacent upper thrust dynamic pressure grooves in the circumferential direction.

6. The spindle motor of claim 2, wherein the lower thrust dynamic pressure grooves are shallower than the upper thrust dynamic pressure grooves.

7. The spindle motor of claim 2, wherein the upper and lower thrust dynamic pressure grooves have a spiral shape, and
an angle formed between an extension line of an inner edge of the lower thrust dynamic pressure groove and the center of rotation and a tangent line at the inner edge of the lower thrust dynamic pressure groove is smaller than an angle formed between an extension line of an inner edge of the upper thrust dynamic pressure groove and the center of rotation and a tangent line at the inner edge of the upper thrust dynamic pressure groove.

8. The spindle motor of claim 2, wherein the upper and lower thrust dynamic pressure grooves have a herringbone shape, and
an angle formed between an outer wing portion and an inner wing portion of the lower thrust dynamic pressure groove is larger than an angle formed between an outer wing portion and an inner wing portion of the upper thrust dynamic pressure groove.

9. The spindle motor of claim 1, wherein the base member is formed by performing plastic working on a rolled steel sheet.

10. A spindle motor comprising:
a hydrodynamic bearing assembly including a shaft, a sleeve rotatably supporting the shaft by fluid dynamic pressure, and upper and lower thrust members protruding from the shaft in an outer radial direction to form thrust dynamic pressure bearings between the upper and lower thrust members and members facing the upper and lower thrust members at the time of relative rotation of the shaft and the sleeve;
a base member having the hydrodynamic bearing assembly mounted thereon and formed of a magnetic material;
an electromagnet mounted on the base member; and
a magnet mounted in a rotating member, one of the shaft and the sleeve, to interact with the electromagnet,
wherein upward thrust dynamic pressure floating the rotating member upwardly in an axial direction among thrust dynamic pressures generated between the upper and lower thrust members and the members facing the upper and lower thrust members, is greater than downward thrust dynamic pressure pulling the rotating member downwardly in the axial direction.
